(19) United States
(12) Patent Application Publication
(10) Pub. No.: US 2024/0249571 A1
(43) Pub. Date: Jul. 25, 2024

(54) SYSTEMS AND METHODS FOR IDENTIFYING SUBSETS OF DATA IN A DATASET

(71) Applicant: Tesla, Inc., Austin, TX (US)

(72) Inventors: Adam Raudonis, Austin, TX (US); Mikhail Alekseev, Austin, TX (US); Syris Norelli, Austin, TX (US); Pete Scheutzow, Austin, TX (US)

(73) Assignee: Tesla, Inc., Austin, TX (US)

(21) Appl. No.: 18/419,234

(22) Filed: Jan. 22, 2024

Related U.S. Application Data
(60) Provisional application No. 63/480,912, filed on Jan. 20, 2023.

(51) Int. Cl. G07C 5/08

(52) U.S. Cl. CPC G07C 5/0841

(57) ABSTRACT

Presented herein are systems and methods for identifying subsets of data in a dataset. In examples, a computing device can receive data associated with operation of at least one vehicle, determine a plurality of events that occurred during based on the operation of the at least one vehicle, receive data associated with a request, the request specifying one or more event types, and determine a set of events from among the plurality of events based on the one or more event types specified by the request. In examples, the computing device can generate event data associated with the operation of the at least one vehicle in the environment during the points in time corresponding to each event of the set of events and transmit the event data to the device associated with the request.

### CROSS-REFERENCE TO RELATED PATENT APPLICATIONS

The present application claims priority to U.S. Provisional Application No. 63/480,912, filed Jan. 20, 2023, which is incorporated herein by reference in its entirety for all purposes.

### TECHNICAL FIELD

The present disclosure generally relates to the identification of subsets of data in a dataset that are responsive to requests.

### BACKGROUND

Recent technological advances are enabling automation of an increasing number of driving functions traditionally performed by humans. For example, many vehicles now include systems that enable operation at the Society of Automotive Engineers (SAE)'s Levels 2-4. These systems can support partial automation of functions such as automated emergency braking, adaptive cruise control, and lane keep assist (Level 2); conditional automation of functions such as complete control of the vehicle while certain conditions are satisfied (Level 3), and high automation of functions such as complete control of the vehicle without requiring driver oversight when operating within a certain operational design domain (Level 4). But as the capabilities of these systems increases, so, too, does the need for data collection and retrieval in support the underlying development efforts.

Conventional techniques for collecting data to support these development efforts involve driving vehicles for tens to thousands of miles and storing the data generated by the sensors installed on vehicles during operation. This data can represent thousands of hours of vehicle operation, many of which are uneventful. As the volume of data collected grows, it can become increasingly difficult to quickly and effectively isolate portions of the data that are relevant for certain development tasks. Further, as developers collect data on disparate computing devices during development, portions of the data are unnecessarily duplicated and, in turn, consume computing resources unnecessarily.

### SUMMARY

To facilitate the parsing and analysis of data collected during vehicle operation, systems and methods are provided herein for identifying subsets of data in a dataset.

Aspects of the present disclosure of systems, methods, devices, apparatus, and non-transitory computer readable media for identifying subsets of data in a dataset. In embodiments, at least one processor is programmed to receive data associated with operation of at least one vehicle in an environment, the operation of the at least one vehicle occurring during at least one period of time; determine a plurality of events that occurred during the at least one period of time based on the operation of the at least one vehicle in the environment, each event of the plurality of events having an event type; receive, from a device, data associated with a request, the request specifying one or more event types; determine a set of events from among the plurality of events based on the one or more event types specified by the request, each event from the set of events occurring at points in time associated with the at least one period of time; generate event data associated with the operation of the at least one vehicle in the environment during the points in time corresponding to each event of the set of events, and transmit the event data to the computing device associated with the request, the event data configured to cause a display associated with the computing device to generate a user interface representing the operation of the at least one vehicle.

The request may specify at least one event type corresponding to a change in a state of the at least one vehicle. When determining the plurality of events, the at least one processor may be programmed to: determine the change in the state of the at least one vehicle during the at least one period of time. Additionally, or alternatively, when determining the plurality of events, the at least one processor may be programmed to: determine the presence of the one or more scenarios, agents, or objects in the environment at points in time during the at least one period of time.

When generating the event data associated with the operation of the at least one vehicle in the environment, the at least one processor may be programmed to: generate the event data based on the set of events and the data generated during the operation of the at least one vehicle at the points in time corresponding to an occurrence of each event in the set of events.

The at least one processor may be further programmed to: determine a trigger based on the request, the trigger configured to cause a device installed in the at least one vehicle to store data associated with operation of at least one vehicle in an environment; and provide data associated with the trigger to the at least one vehicle to cause the trigger to be implemented by the device installed in the at least one vehicle. The at least one processor may be further programmed to receive the data associated with operation of at least one vehicle in an environment based on providing the data associated with the trigger to the at least one vehicle.

The at least one processor may be further programmed to determine a trigger based on the request, the trigger configured to cause a device installed in the at least one vehicle to store data associated with operation of at least one vehicle in an environment; and determine whether the trigger satisfies a probability threshold based on applying the trigger to the data associated with operation of at least one vehicle in an environment. The at least one processor may be further programmed to: provide data associated with the trigger to the at least one vehicle to cause the trigger to be implemented by the device installed in the at least one vehicle based on determining that the trigger satisfies the probability threshold The at least one processor may be further programmed to: update the trigger based on determining that the trigger does not satisfy the probability threshold; and provide data associated with the trigger to the at least one vehicle to cause the trigger to be implemented by the device installed in the at least one vehicle based on updating the trigger.

In an embodiment, a computer-implemented method may comprise receiving, by at least one processor, data associated with operation of at least one vehicle in an environment, the operation of the at least one vehicle occurring during at least one period of time; determining, by the at least one processor, a plurality of events that occurred during the at least one period of time based on the operation of the at least one vehicle in the environment, each event of the plurality of events having an event type; receiving, by the at least one processor and from a device, data associated with a request, the request specifying one or more event types; determining, by the at least one processor, a set of events from among the plurality of events based on the one or more event types specified by the request, each event from the set of events occurring at points in time associated with the at least one period of time; generating, by the at least one processor, event data associated with the operation of the at least one vehicle in the environment during the points in time corresponding to each event of the set of events, and transmitting, by the at least one processor, the event data to the computing device associated with the request, the event data configured to cause a display associated with the computing device to generate a user interface representing the operation of the at least one vehicle.

In another embodiment, a non-transitory machine-readable medium has computer-executable instructions stored thereon that, when executed by one or more processors, may cause the one or more processors to perform operations comprising: receiving data associated with operation of at least one vehicle in an environment, the operation of the at least one vehicle occurring during at least one period of time; determining a plurality of events that occurred during the at least one period of time based on the operation of the at least one vehicle in the environment, each event of the plurality of events having an event type; receiving, from a device, data associated with a request, the request specifying one or more event types; determining a set of events from among the plurality of events based on the one or more event types specified by the request, each event from the set of events occurring at points in time associated with the at least one period of time; generating event data associated with the operation of the at least one vehicle in the environment during the points in time corresponding to each event of the set of events, and transmitting the event data to the computing device associated with the request, the event data configured to cause a display associated with the computing device to generate a user interface representing the operation of the at least one vehicle.

It is to be understood that both the foregoing general description and the following detailed description are exemplary and explanatory, and are intended to provide further explanation of the embodiments described herein.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of system for collecting and analyzing data generated during vehicle operation, in accordance with an embodiment.

FIG. 1B illustrates various sensors associated with an ego, in accordance with an embodiment.

FIG. 1C illustrates the components of a vehicle, in accordance with an embodiment.

FIG. 2 illustrates a flow diagram of a method of collecting and analyzing data generated during vehicle operation, in accordance with an embodiment.

FIGS. 3A and 3B are diagrams of an implementation of a process for collecting and analyzing data generated during vehicle operation, in accordance with an embodiment.

FIGS. 4A-4E are diagrams of an implementation of a process for identifying subsets of data in a dataset, in accordance with an embodiment.

FIGS. 5A-5D illustrate an example user interface for identifying subsets of data in a dataset, in accordance with an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

Conventional techniques and technological solutions available today do not include systems, tools, or platforms that enable efficient collection and analysis of data generated during vehicle operation. To address this need, disclosed herein are techniques that involve carefully collecting and analyzing data generated during vehicle operation. More specifically, certain techniques described herein involve: receiving, by at least one processor, data associated with operation of at least one vehicle in an environment, the operation of the at least one vehicle occurring during at least one period of time; determining, by the at least one processor, a plurality of events that occurred during the at least one period of time based on the operation of the at least one vehicle in the environment, each event of the plurality of events having an event type; receiving, by the at least one processor and from a device, data associated with a request, the request specifying one or more event types; determining, by the at least one processor, a set of events from among the plurality of events based on the one or more event types specified by the request, each event from the set of events occurring at points in time associated with the at least one period of time; generating, by the at least one processor, event data associated with the operation of the at least one vehicle in the environment during the points in time corresponding to each event of the set of events, and providing, by the at least one processor, the event data to the device.

By implementing the techniques described herein, systems (such as computing devices installed on vehicles (sometimes referred to as egos), servers, and/or the like) can interact with one another to quickly and efficiently request and provide data associated with the operation of at least one vehicle. For example, in the case where a developer needs additional data to train a model (e.g., a machine learning model used for perception) to improve the ability of the model to classify a particular type of object encountered by a vehicle under particular circumstances (e.g., traffic cones in proximity to vehicles traveling over 60 mph), the developer may cause a computing device to transmit a request specifying such object types and circumstances. A different computing device (e.g., a server) may receive the request and match the request to events that occurred in a database (e.g., events where traffic cones were identified in association with vehicles traveling over 60 mph). By directing such requests through dedicated computing devices (e.g., servers collecting, analyzing, and managing data associated with the operation of at least one vehicle) the potential need for duplicated efforts across computing devices when reviewing data associated with operation of at least one vehicle is eliminated. And as new events are defined, subsequent requests associated with such requests may be processed while minimizing use of computing resources. This, in turn, reduces the need for extra processing that would otherwise be used to identify data corresponding to events responsive to requests. Further, in the case where the computing device transmitting the request has less computing resources as compared to the computing resources receiving the request, processing of the data associated with the operation of the at least one vehicle can be performed faster than if performed solely by the computing device requesting such data.

In some embodiments, one or more aspects of the present disclosure relate to the configuration and management of data provided by vehicles to network service. By way of illustrative example, aspects of the present application correspond to the management of data received from a plurality of vehicles. Illustratively, vehicle data can include but is not limited to, data associated with the operation of at least one vehicle, including vehicle operational information, vehicle parameters, sensor configuration information, sensor values, environmental information, and the like. The data can be transmitted to a network service provider. The data can be composed of various data types or formats. The data can be managed by the network service provider, and a third party can access to the vehicle data by communicating with the network service provider. The third party, for example, may include but is not limited to vehicle administrator(s), vehicle manufacturer(s), vehicle service provider(s), vehicle owner(s), etc. Accordingly, the network service provider may manage the vehicle data to provide access to the third party.

In accordance with an illustrative embodiment, one or more aspects of the present disclosure relate to the configuration and accessibility of data associated with the operation of at least one vehicle that is provided to one or more third parties. The network service provider can facilitate the vehicle data management to provide certain vehicle data requested from the third parties. For example, the network service provider can be configured to process the vehicle data received from a plurality of data and store it in its database (sometime referred to as a data store). In this example, the third parties may request access to certain data, and the network service provider may scan the data store to provide the requested data to the third parties.

Generally, conventional approaches for providing data to third parties present significant technical challenges for third parties and network service providers. More specifically, in response to receiving a specific request from a third party, the network service provider scans its data store and provides a list of the related data. Then, the third parties need to download all of the data and further process the downloaded data to identify relevant portions of the data responsive to their request. In this regard, even though the volume of the data is large, the third parties need to download the entirety of the data.

In addition, the network service provider may provide the data as a bundle of data, and thus, the third parties need to download the bundle of data, and further process the data to find specific data requested. For example, if the data is composed of a plurality of video clips and the third parties' request corresponds to scenarios where a vehicle enters a tunnel, the network service provider may provide any video clips that include the tunnel. In this example, even though each video clip includes a few frames that indicate the tunnel entrance, third parties need to download the whole video clip and determine the frames that indicate the tunnel entrance. Furthermore, each video clip may include a plurality of sensor signals (e.g., vehicle attributes, driving environment, operational parameters, etc.), the third parties have to process the plurality of sensor signals, even though only one or two sensor signals are requested by the third parties.

In addition, the third parties may have a limitation in requesting the data. For example, if the third parties' request is data associated with one or more events, the third parties need to download all of the data and process the downloaded data. In some aspects, since all of the data is too large, the third parties may not able to download the data. Instead, the third parties may monitor the incoming data to determine the incoming data, including the events.

To address at least a portion of the above-identified inefficiencies, a network service provider can facilitate data management to provide the data to the third parties more efficiently. The network service provider can process the incoming data associated with the operation of the at least one vehicle and store the data in a certain data format, such as one or more arrays of sensor signals representing, for example, vehicle attributes, driving environments, operational parameters, etc. In an example, each video clip included in the data can be stored as arrays, such as an array of reference time and the vehicle speed, an array of reference time and vehicle power consumption, etc. These arrays can be stored as metadata with an index. Advantageously, the index can be utilized in scanning the data relevant to the user's request. For example, the network service provider, in response to receiving a request specifying sensor signals (e.g., sensor signal parameters) that the user is interested in, may scan the metadata by utilizing the index. In this example, only the data associated with the index relevant to the user's request can be provided to the user. Thus, the user can access to the data that has the index relevant to the user's query without downloading whole video clips that include the vehicle data requested by the user. For example, a video clip composed of video data can be stored by indexing each video data. In this example, the network service provider may search each vehicle data's index within the video clip. Then, the network service provider may provide access or provide data only related to the user's request. Thus, the user does not need to download the video clip to further search for the relevant video data. Instead, the network service provider provides only vehicle data relevant to the user's request.

The network service provider can also provide an input interface where the third parties can request the vehicle data by using the input interface. In some embodiments, the third parties can provide the input by using logical programming, such as python code. In these embodiments, the third parties can utilize a commercially available library, such as NumPy or SciPy. For example, if the third parties need to request vehicle data that includes vehicle speed above a certain speed and operating more than 5 hours, the third parties can write a query using the python code including the request. In some embodiments, the query can be written in a customizable format, such as by including any query related to the vehicle's operational parameters, environment, driver's behavior, etc. Then, the network service provider may scan its metadata and provide the list of sensor signals that includes the request. In some embodiments, the network service provider can receive the input as one or more triggers (triggering events). In these embodiments, the network service provider may automatically determine whether incoming data is associated with the triggers. In other embodiments, the network service provider may scan its metadata to determine whether any of the stored vehicle data is associated with the triggers.

The network service provider can also manage the data associated with the operation of the at least one vehicle by grouping the data (e.g., portions of the data) based on the sensor signals. In some embodiments, the data received from the plurality of vehicles can be stored with a plurality of arrays that each array represents a set of sensor signals. In these embodiments, the arrays can be grouped based on their representing sensor signals. For example, data received from vehicle 1, vehicle 2, and vehicle 3 can be processed as arrays, such as arrays of vehicle speed and time and vehicle jerking incident and time. In this example, the array of vehicle speed and time associated with the vehicles 1, 2, and 3 can be grouped. Thus, if the third parties request data associated with the operation of the at least one vehicle while operating at a high speed, the network service provider may only scan the data where the speed satisfies the request. The network service provider can also manage its computational resources. For example, the network service provider can monitor the computational resources and dynamically adjust the computational resources.

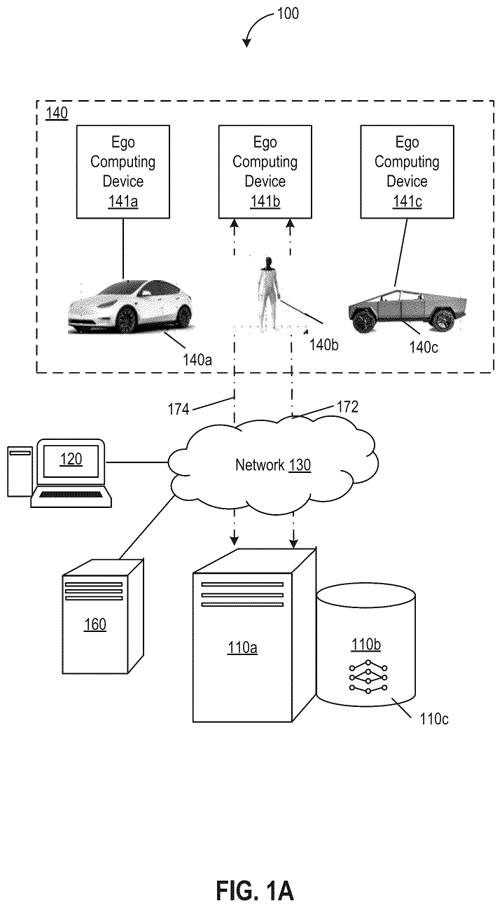

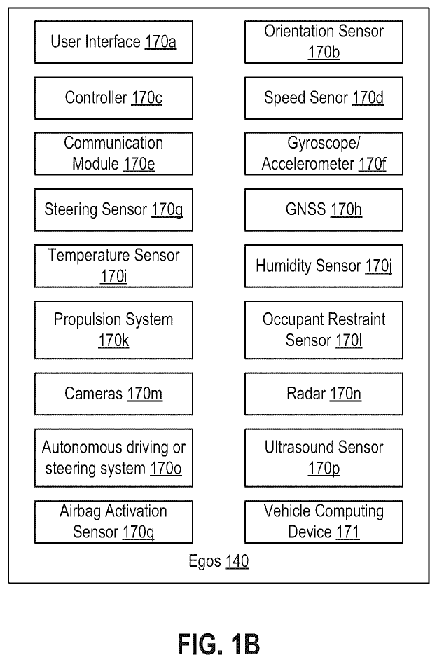

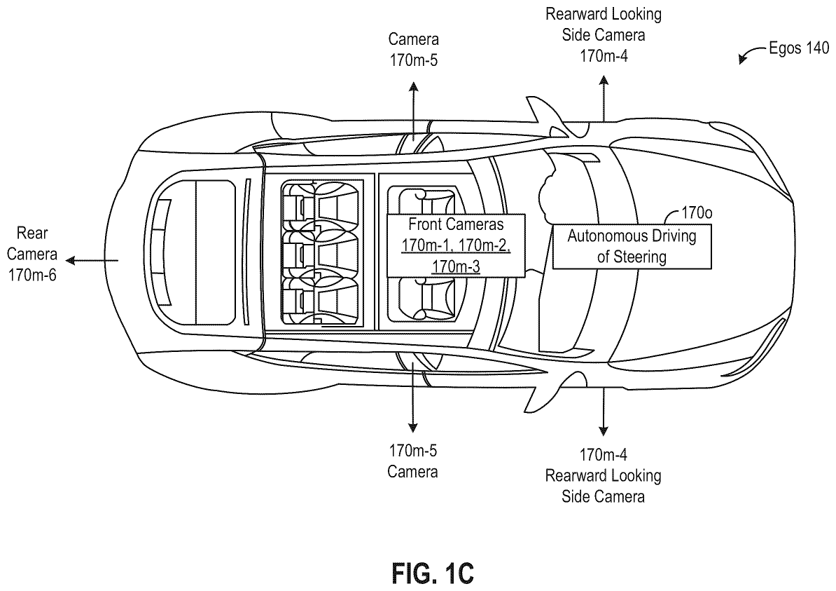

Referring now to FIG. 1A, illustrated is a non-limiting example of components of a system in which the methods and systems discussed herein can be implemented. For instance, an analytics server may collect and analyze data generated during vehicle operation. The analytics server may then provide event data (described herein) to devices based on receiving requests for the event data, the requests specifying one or more event types.

With continued reference to FIG. 1A, an example environment 100 may include an analytics server 110a, a system database 110b, an administrator computing device 120, egos 140a-c (referred to collectively as “egos 140” and individually as “ego 140”), ego computing devices 141a-c (referred to collectively as “ego computing devices 141” and individually as “ego computing device 141”), and a server 160. The environment 100 is not confined to the components described herein and may include additional or other components not shown for brevity, which are to be considered within the scope of the embodiments described herein.

The components mentioned herein may interconnect (e.g., establish a connection to communicate) through a network 130. Examples of the network 130 may include, but are not limited to, private or public LAN, WLAN, MAN, WAN, and the Internet. The network 130 may include wired and/or wireless connections that facilitate communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The environment 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the ego 140a having the ego computing device 141a may transmit its camera feed to the trained AI model(s) 110c and may generate a graph defining lane segments in the environment (e.g., data stream 174). Moreover, the data ingested and/or predicted by the AI model(s) 110c with respect to the egos 140 (at inference time) may also be used to improve the AI model(s) 110c. Therefore, the environment 100 depicts a continuous loop that can periodically improve the accuracy of the AI model(s) 110c. Moreover, the environment 100 depicts a loop in which data received the egos 140 can be used to at training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the environment 100 includes a single analytics server 110a, the environment 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g., when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then execute the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the environment 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B and 1C illustrate block diagrams of sensors integrated within the egos 140, according to an embodiment. The number and position of each sensor discussed with respect to FIGS. 1B and 1C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

With reference to FIG. 1B, the egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140 and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 170l may monitor seatbelt detection and locking/unlocking assemblies, as well as other passenger restraint subsystems. The occupant restraint sensor 170l may include various environmental and/or status sensors, actuators, and/or other devices facilitating the operation of safety mechanisms associated with the operation of the egos 140. For example, occupant restraint sensor 170l may be configured to receive motion and/or status data from other sensors depicted in FIG. 1B. The occupant restraint sensor 170l may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior- or exterior-facing cameras of the egos 140. For instance, as depicted in FIG. 1C, the egos 140 may include one or more interior-facing cameras that may monitor and collect footage of the occupants of the egos 140. The egos 140 may include eight exterior facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

With continued reference to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 170o configured to use data collected via various sensors (e.g., radar 170n, speed sensor 170d, and/or ultrasound sensors 170p) to autonomously navigate the ego 140.

Therefore, autonomous driving or steering system 170o may analyze various data collected by one or more sensors described herein to identify driving data. For instance, autonomous driving or steering system 170o may calculate a risk of forward collision based on the speed of the ego 140 and its distance to another vehicle on the road. The autonomous driving or steering system 170o may also determine whether the driver is touching the steering wheel. The autonomous driving or steering system 170o may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of training AI models 110c, the analytics servers 110a can collect data from egos 140 to train the AI model(s) 110c. Before executing the AI model(s) 110c to generate or predict a graph defining lane segments, the analytics server 110a may train the AI model (s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A and 1B (e.g., a processor of the egos 140).

To train the AI model(s) 110c, the analytics server 110a may first employ one or more of the egos 140 to drive a particular route. While driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos' 140 surroundings. For instance, the sensor data may indicate various objects having mass in the surroundings of the one or more of the egos 140 as they navigate their route.

In operation, as the one or more egos 140 navigate, their sensors collect data and transmit the data to the analytics server 110a, as depicted in the data stream 172. In some embodiments, the one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos' 140 surroundings are included within the second dataset. In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may generate a training dataset using data collected from the egos 140 (e.g., camera feed received from the egos 140). The training dataset can identify or include a set of examples. Each example can identify or include input data and expected output data from the input data. In each example, the input can include the collected data, such as sensor data (e.g., video or image from one or more cameras) and map data (e.g., navigation map) from egos 140. The output can include environment features (e.g., attributes gathered from the sensor data), map features (e.g., attributes in navigation map such as topological features and road layouts), classifications (e.g., a type of topology), and an output token (e.g., a combination of environment features, map features, and classifications) to be included in a graph defining lane segments, among others. In some embodiments, the output can be created by a human reviewer examining the input data.

Using the training dataset, the analytics server 110a may feed the series of training datasets to the AI model(s) 110c and obtain a set of predicted outputs (e.g., environment features, map features, classifications, and output tokens). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

In some embodiments, the analytics server 110a may use a supervised method of training For instance, using the ground truth and the visual data received, the AI model(s) 110c may train itself, such that it can predict an output. As a result, when trained, the AI model(s) 110c may receive sensor data and map data, analyze the received data, and generate the token. In some embodiments, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c.

With the establishment of the AI model 110c, the analytics server 110a can transmit, send, or otherwise distribute the weights of the AI model 110c to each of the ego computing devices 141a-c. Upon receipt, the ego computing device 141a-c can store and maintain the AI model 110c on a local storage. Once stored and loaded, the ego computing device 141a-c can use in processing newly acquired data (e.g., sensor and map data) to create graphs to define lane segments to autonomously navigate the respective ego 140a-c through the environment. From time to time, the analytics server 110a can transmit, send, or otherwise distribute the updated weights of the AI model 110c to update instances of the AI model 110c on the ego computing devices 141a-c.

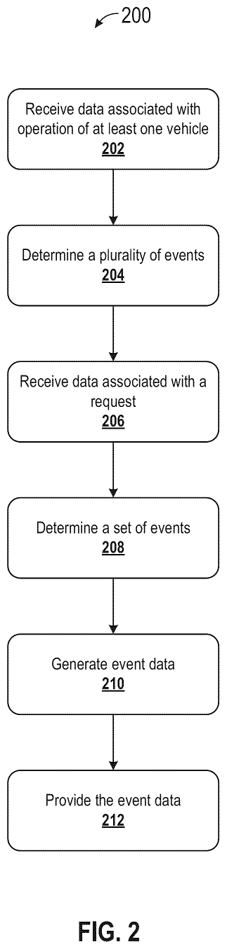

Referring now to FIG. 2, illustrated is a non-limiting example of a flow diagram for a method 200 of identifying subsets of data in a dataset. The method 200 can be implemented using any of the components described herein, such as one or more components of an analytics server (e.g., an analytics server that is the same as, or similar to, the analytics server 110a of FIG. 1A). While the method 200 includes steps as described herein, other embodiments may include additional or alternative steps or may omit one or more steps.

In some implementations, the method 200 is executed by the analytics server. However, one or more steps of the method 200 may be executed by one or more other computing devices separate from, and/or including the analytics server, such as another analytics server, one or more computing devices of at least one vehicle (e.g., egos 140), and/or one or more other computing devices operating in a distributed computing system (e.g., a distributed computing system that is the same as, or similar to, the distributed computing system described in FIGS. 1A-C). For instance, one or more computing devices of an ego may locally perform some or all steps described with respect to method 200.

At step 202, an analytics server receives data associated with operation of at least one vehicle. For example, the analytics server may receive (e.g., collect) data associated with the operation of the at least one vehicle from one or more egos (e.g., one or more egos that are the same as, or similar to, egos 140 of FIG. 1). In some implementations, the at least one vehicle may be configured to collect the data and transmit the collected data. The analytics server may receive the data associated with the operation of the at least one vehicle periodically (e.g., at predetermined time intervals), when one or more conditions are satisfied (e.g., when a system of the ego establishes a communication connection with the analytics server to transmit the data to the analytics server, when a system of the ego determines that a predetermined amount of onboard storage has been consumed, and/or the like), or continuously (e.g., in real-time). In these examples, the data associated with the operation of the at least one vehicle may be generated as the egos are operating in environments, such as when traversing drivable surfaces (with respect to egos that are the same as, or similar to, ego 140a and 140c of FIG. 1A) and/or traversable (e.g., walkable) surfaces (with respect to egos that are the same as, or similar to ego 140b of FIG. 1A).

Where the ego is operating within its environment (e.g., along drivable and/or traversable surfaces), a computing device (e.g., a computing device that is the same as, or similar to, the vehicle computing device 171 of FIG. 1B) of the ego may monitor operation of one or more of the components of the ego (e.g., one or more components illustrated by FIG. 1B). The computing device may then generate the data associated with the operation of the vehicle based on the operation of the one or more components. In this example, the computing device may be configured to be in communication with the one or more components and generate and store the data generated by the one or more components represented by at least a portion of the data associated with the operation of the at least one vehicle. This process may sometimes be referred to as logging or data logging. It will be understood that the computing device may store the data in a local database (e.g., a database that is included in, or maintained in separate storage by, the computing device that is monitoring the one or more components).

The computing device may monitor the operation of one or more sensors of the vehicle and generate the data associated with the operation of the at least one vehicle based on (e.g., by including) the sensor data associated with one or more sensors of the ego. The sensor data may include one or more sensor signals generated by the one or more sensors during the operation of the ego vehicle. In examples, the sensor data includes: orientation sensor data associated with sensor signals generated by one or more orientation sensors of the ego, speed sensor data associated with sensor signals generated by one or more speed sensors of the ego, gyroscope/accelerometer sensor data associated with sensor signals generated by one or more gyroscopes/accelerometers of the ego, steering sensor data associated with one or more sensor signals generated by a steering sensor of the ego, GNSS sensor data associated with one or more sensor signals generated by a GNSS of the ego, temperature sensor data associated with one or more sensor signals generated by a temperature sensor of the ego, humidity sensor data associated with one or more sensor signals generated by a humidity sensor of the ego, occupant restraint sensor data associated with one or more occupant restraint sensors of the ego, camera data associated with one or more sensors signals generated by one or more cameras (focused outward or inward relative to the ego) of the ego, radar data associated with sensor signals generated by one or more radars of the ego, ultrasound sensor data associated with one or more sensor signals generated by ultrasound sensors of the ego, airbag activation sensor data associated with sensor signals generated by airbag activation sensors of the ego, and/or any other sensor data described herein.

The data associated with the operation of the at least one vehicle may include user interface data associated with inputs/outputs provided to or by passengers within the ego via a user interface (e.g., a display device, a torque sensor corresponding to the steering wheel, and/or the like). Additionally, or alternatively, the data associated with the operation of the at least one vehicle may include controller data associated with a controller of the ego. In this example, the controller may control operation of one or more devices within the ego (e.g., device that control vehicle acceleration, braking, windshield wipers, communication of user input, and/or the like) which is simultaneously included in the data associated with the operation of the at least one vehicle. In some examples, the data associated with the operation of the at least one vehicle may include data generated during operation of a communication module. For example, data transmitted and/or received via the communications module from and/or to systems of the ego may be included in the data associated with the operation of the at least one vehicle. In some implementations, the egos may generate the data associated with the operation of the at least one vehicle based on operation of a propulsion system. For example, the data may include data generated by the propulsion system (e.g., control signals to cause the ego to increase or decrease speed and acceleration).

The data associated with operation of the at least one vehicle may include autonomous driving or steering system data associated with operation of an autonomous driving or steering system. For example, during operation, an autonomous driving or steering system may receive data (e.g., from one or more sensors such as cameras, radars, and/or one or more other sensors described with respect to FIG. 1B) and perform one or more operations. Such operations can include, for example, perception, planning, and control which support the automated movement of the ego through its environment toward a destination. As the autonomous driving or steering system performs the one or more operations, the data generated by the autonomous driving or steering system during performance of the operations may be included in the data associated with operation of the at least one vehicle. Additionally, or alternatively, the data associated with the operation of the at least one vehicle may include autonomous driving or steering system data that is generated during simulations involving an autonomous driving or steering system. For example, at a first point or period of time, the data associated with operation of the at least one vehicle may be provided to an autonomous driving or steering system installed on the at least one vehicle, causing the autonomous driving or steering system to provide as an output the autonomous driving or steering system data which is then used to update the data associated with the operation of the at least one vehicle. At a second (later) point or period in time, the data associated with the operation of the at least one vehicle may be provided to a different autonomous driving or steering system (e.g., a later version of the autonomous driving or steering system) while the autonomous driving or steering system is simulated (sometimes referred to as being “replayed”). The data associated with the operation of the at least one vehicle may again be updated to include the data output by the autonomous driving or steering system.

With continued reference to perception, the autonomous driving or steering system may cause a perception system to receive data necessary to perceive objects and/or agents in proximity to the ego and classify the objects or agents (e.g., as cones, traffic signals, pedestrians, bicyclists, and/or the like). This data can include the camera data, the radar data, the ultrasound data, and/or the like. The perception system may then generate data associated with the classification of the objects and/or agents and the computing system may include the data in the data associated with operation of the at least one vehicle. In some examples, the computing system may include the inputs, intermediate determinations, and outputs of the perception system in the data associated with operation of the at least one vehicle.

In reference to planning, the autonomous driving or steering system may provide data to a planning system. The data can include the data generated by the perception system, map data associated with one or more maps, and/or data associated with (e.g., specifying) a route and/or target destination. The planning system may then determine one or more maneuvers to perform (e.g., lane changing, overtaking, yielding, and/or the like) as well as one or more trajectories along which the ego should operate. Once determined, the planning system may provide data associated with one or more trajectories to a controller to cause operation of the ego in accordance with the one or more trajectories. The computing system may include the data associated with the one or more trajectories that is output by the planning system with the data associated with the operation of the at least one vehicle. In some examples, the computing system may include the inputs, intermediate determinations, and outputs of the planning system in the data associated with operation of the at least one vehicle.

Referring to control, the autonomous driving or steering system may provide data to a control system. The data can include the data provided to the planning system and/or the data provided as an output to the planning system. The control system may then determine data associated with one or more control signals based on the data provided to the control system. The one or more control signals may be configured to cause actuation of one or more systems of the ego (e.g., a propulsion system that is the same as, or similar to, the propulsion system 170k of FIG. 1B, a steering system involved in controlling actuators that change the steering angle of the ego, and/or the like). The computing system may include the data associated with the one or more control signals with the data associated with the operation of the at least one vehicle. In some examples, the computing system may include the inputs, intermediate determinations, and outputs of the control system in the data associated with operation of the at least one vehicle.

The data associated with operation of the at least one vehicle may be generated during at least one period of time. For example, the data associated with the operation of at least one vehicle may be associated with (e.g., correspond to) a period of time during which the at least one vehicle is operated. In such an example, the data may be further associated with one or more timestamps. The one or more timestamps may indicate one or more points in time when certain portions of the data associated with operation of at least one vehicle were generated. In one illustrative example, as the vehicle operates, camera data associate with one or more sensors signals generated by one or more cameras may be included in the data associated with operation of at least one vehicle. The camera data may be further associated with one or more timestamps that correspond to the point in time at which the one or more sensor signals were generated.

The data associated with operation of the at least one vehicle is transmitted to a vehicle data management system (sometimes referred to as a vehicle data management service). For example, as the data associated with the operation of the at least vehicle (sometimes referred to as vehicle data), the vehicles (e.g., the egos) that generate the data associated with operation of the at least one vehicle may transmit the data to the vehicle data management system. In some examples, the vehicle data management system is the same as, or similar to, the analytics server. Additionally, or alternatively, the vehicle data management system may be associated with (e.g., may work in coordination with) the analytics server to perform one or more of the operations described herein.

The vehicle data management system may be configured to receive (e.g., collect) the data associated with the operation of the at least one vehicle. In examples, the at least one vehicle (e.g., the computing device of the at least one vehicle) may be configured to collect, store, and periodically, conditionally, or continuously transmit the data associated with operation of the at least one vehicle to the vehicle data management system. In some implementations, the vehicle data management system is configured to receive the data associated with operation of the at least one vehicle based on the computing system of the vehicle determining that one or more events are represented by the data associated with operation of the at least one vehicle. As will be discussed below, the computing system of the at least one vehicle may be configured to determine whether one or more events occurred (e.g., based on one or more triggers corresponding to events, scenarios, locations based on geographic coordinates or other identifiers, and/or the like) and store the data associated with operation of the at least one vehicle based on whether the one or more events occurred.

At step 204, the analytics server determines a plurality of events. For example, the analytics server may determine the plurality of events, where each event of the plurality of events is associated with (e.g., occurs at) one or more points in time (e.g., a point in time, a period of time, and/or the like). In some examples, the analytics server may determine an event type for each event of the plurality of events. The analytics server may determine the event type based on the analytics server processing the data associated with operation of the at least one vehicle. In an example, the analytics server may process the data associated with the operation of the at least one vehicle by converting the data to arrays of sensor signals. When processing the data, the analytics server may associate a tag with each event of the plurality of events based on the analytics server determining that the one or more events occurred at one or more points in time, the tag being associated with (e.g., representing) an event type of each event of the plurality of events.

In an illustrative example, the analytics server may process the sensor signals generated by one or more cameras of the at least one vehicle. The analytics server may then generate the arrays shown below in Table 1a, 1b, and 1c representing the state of one or more other components of the at least one vehicle. As shown in Table 1a, the vehicle speed signal is represented in an array of time stamp and vehicle speed. As shown in Table 1b, the vehicle battery status signal is represented in an array of time stamp and vehicle battery status. As shown in Table 1c, the vehicle heater operation signal is represented in an array of time stamp and vehicle heater operation. In some examples, these arrays can be stored as a metadata. For example, each image may include the information corresponding to each image as metadata (e.g., a first image may be captured at 1:56 PM while the at least one vehicle traveled at 60 mph, a second image may be captured at 1:57 PM while the at least one vehicle traveled at 66mph, and so on). Tables 1a, 1b, and 1c are merely provided as illustrative examples, and the present disclosure is not limited thereto.

TABLE 1a

| 01:56 | 01:57 | 01:58 | 01:59 | 02:00 | 02:01 | 02:02 | 02:03 | 02:04 | 02:05 |
|---|---|---|---|---|---|---|---|---|---|
| PM | PM | PM | PM | PM | PM | PM | PM | PM | PM |
| 60 mph | 66 mph | 70 mph | 66 mph | 80 mph | 60 mph | 75 mph | 78 mph | 95 mph | 55 mph |

TABLE 1b

| 01:56 | 01:57 | 01:58 | 01:59 | 02:00 | 02:01 | 02:02 | 02:03 | 02:04 | 02:05 |
|---|---|---|---|---|---|---|---|---|---|
| PM | PM | PM | PM | PM | PM | PM | PM | PM | PM |
| 100% | 99% | 98% | 97% | 78% | 60% | 50% | 48% | 47% | 46% |

TABLE 1c

| 01:56 | 01:57 | 01:58 | 01:59 | 02:00 | 02:01 | 02:02 | 02:03 | 02:04 | 02:05 |
|---|---|---|---|---|---|---|---|---|---|
| PM | PM | PM | PM | PM | PM | PM | PM | PM | PM |
| Heater | Heater | Heater | Heater | Heater | Heater | Heater | Heater | Heater | Heater |
| off | off | off | off | on | on | on | off | off | off |

The analytics server may also process the data associated with the operation of the at least one vehicle by grouping the data based on the sensor signals. In some embodiments, each of the sensor signals received can be included in a plurality of arrays, where each array represents a sensor signal, such as shown in the above tables. In these embodiments, the arrays can be grouped based on their representing vehicle signal. For example, sensor signals received from vehicle 1, vehicle 2, and vehicle 3 can be processed as arrays, such as arrays of vehicle speed and time and vehicle jerking incident and time. In this example, the array of vehicle speed and time associated with vehicle 1, vehicle 2, and vehicle 3 can be grouped. Thus, if request involves the operation of the at least one vehicle at a high speed (e.g., a speed over a predetermined speed), the analytics server may scan the sensor signals that satisfy this requirement, while forgoing scanning other sensor signals. This can save computing resources that would otherwise be needed to scan the entirety of the data associate with the operation of the at least one vehicle when responding to a request.

When processing the data associated with operation of the at least one vehicle, the analytics server may identify the occurrence of each event of the plurality of events during the period of time. Additionally, or alternatively, the analytics server may determine the event type based on one or more tags associated with the data associated with operation of the at least one vehicle. In this example, the computing system associated with each vehicle of the at least one vehicle may associate one or more tags with one or more points in time based on the computing system determining that the one or more events occurred at the one or more points in time. It will be understood that the analytics server may process the events by transforming the data associated with the operation of the at least one vehicle to corresponding arrays, each array representing (as an example) a time at which the event occurred, a speed at which the vehicle was traveling, a state of one or more components of the vehicle (e.g., a heater and/or the like), and/or the like.

An event type may be associated with a change in a state of the at least one vehicle. For example, an event type may be associated with a change in state where a driver engages or disengages one or more systems of the vehicle such as windshield wipers, headlights, a gas pedal or brakes, and/or the like. Additionally, or alternatively, the event type may be associated with a change in state where one or more systems of the vehicle (e.g., the heating and air conditioning system) automatically engages or disengages. In some implementations, the analytics server determines that an event occurred based on the analytics server determining that the change in state occurred. Additionally, or alternatively the computing system of the at least one vehicle may determine that the event occurred based on the computing device monitoring the other systems of the vehicle and include a tag indicating that the event occurred. In this example, the analytics server may determine that the event occurred based on the tags included in the data associated with the operation of the at least one vehicle. As described herein, the computing device of the vehicle may determine that the event occurred based a trigger.

In some examples, event types can represent one or more scenarios. For example, an event type may be associated with scenarios such as cut-ins, where vehicles move from an adjacent lane of travel into the lane of travel of the at least one vehicle. In other examples, an event type may be associated with scenarios such as j-walking, where an agent (e.g., a pedestrian) crosses the lane of travel of a vehicle in an unguarded section (e.g., an area other than a crosswalk or where a pedestrian is otherwise permitted to cross a lane of travel). In some implementations, the analytics server determines that an event occurred based on the analytics server determining that the one or more objects and/or agents were present, and/or that one or more objects or agents were moving through the environment in accordance with the corresponding event type. Additionally, or alternatively the computing device of the at least one vehicle may determine that the event occurred based on the computing device monitoring the other systems of the vehicle and including a tag indicating that the event occurred.

In yet more examples, event types can represent the presence of one or more agents and/or objects. For example, an event type may be associated with the presence of one or more objects (e.g., traffic cones, plastic or concrete median barriers, traffic signals and/or signs, parked vehicles, and/or the like). In some implementations, the analytics server determines that an event occurred based on the analytics server determining that the one or more objects and/or agents were present at one or more points in time. Additionally, or alternatively the computing system of the at least one vehicle may determine that the event occurred based on the computing device monitoring the other systems of the vehicle and including a tag indicating that the one or more agents and/or objects were present at the one or more points in time.

The analytics server may receive the data associated with operation of at least one vehicle based on the analytics server providing data associated with a trigger to the at least one vehicle. For example, the analytics server may receive input (e.g., via a user such as an autonomous system developer and/or the like) associated with a trigger. In one example, the analytics server may receive input indicating that data associated with the classification of one or more objects and/or agents is to be associated with the trigger. In this example, the analytics server may then generate data associated with the trigger, where the data associated with the trigger is configured to cause the computing device of the at least one vehicle to store and/or transmit the data associated with the trigger to the analytics server. The data associated with the trigger can include data generated by the one or more components of an ego vehicle when the autonomous driving and/or steering system classifies the one or more objects and/or agents in the environment of the at least one vehicle.

The analytics server may determine whether the trigger satisfies a probability threshold. For example, the analytics server may determine whether the trigger satisfies a probability threshold, where the probability threshold represents a degree to which the trigger identifies criteria that result in the accurate identification of one or more events. In examples, the analytics server may determine whether the trigger satisfies the probability threshold based on the analytics server applying the trigger to previously-received data associated with the operation of the at least one vehicle. In the case where the probability threshold is satisfied (e.g., where a predetermined number of events corresponding to the trigger are correctly identified using the trigger, where a percentage of events corresponding to the trigger are correctly identified, and/or the like), the analytics server may provide (e.g., transmit and/or otherwise make available) the data associated with the trigger to the one or more vehicles. The data associated with the trigger may be configured to cause the computing device of the one or more vehicles to implement the trigger. Alternatively, where the probability threshold is not satisfied, the analytics server may provide output associated with an indication that the probability threshold was not satisfied. In this example, the analytics server may receive subsequent input (e.g., via the user) to update one or more aspects of the trigger, and the analytics server may then redetermine whether the updated trigger satisfies the probability threshold. In such an example, when the analytics server determines that the updated trigger satisfies the probability threshold, the analytics server may provide the data associated with the updated trigger to the one or more vehicles. In this example, the data associated with the updated trigger may be transmitted to the computing device(s) of the at least one vehicle.

At step 206, the analytics server receives data associated with a request. For example, the analytics server may receive data associated with a request from a computing device associated with a user such as an autonomous system developer and/or the like. In some examples, the request may be generated based on a computing device associated with the user receiving input from the user that specifies one or more event types. The one or more event types may be specified by identifying one or more predetermined event types and/or one or more criteria that correspond to an event type (e.g., an event type that is defined by the user in the request). In some embodiments, the user (sometimes referred to as a third party) provides input that is received by the analytics server via a request, the input represented as a logical representation by utilizing, for example, python code and/or any other suitable representation.

The analytics server may analyze the request. For example, the analytics server may analyze (e.g., process) the request to identify one or more aspects of the request. In some embodiments, the request may be represented as a logical representation based on, for example, python code. In one illustrative example, where the user provides input which is represented as a logical representation requesting data associated with operation of the at least one vehicle where vehicle speeds are above a speed limit of 60 mph, the analytics server may analyze the input (as represented by the request) and scan through one or more metadata arrays, such as table la. The analytics server may then provide the corresponding data associated with the operation of the at least one vehicle where the speed exceeded 60 mph. The corresponding data may be provided to the computing device associated with the user that transmitted the request.

The analytics server may receive the request, where the request is associated with one or more triggers (sometimes referred to as triggering events). In these embodiments, the input can be in the form computer-executable data, such as executable scripts provided as input by the user. For example, the trigger may be associated with at least one vehicle operational parameter, such as the determination that a vehicle's location falls within the defined geographic boundary information (e.g., entering into a geofence) or that a vehicle's operational parameter is above a preset threshold value. In some embodiments, the analytics server may perform a debugging of the input and provide if there are any errors.

The analytics server may determine a trigger based on the request. For example, the analytics server may determine the event type associated with the request and the analytics server may identify a corresponding trigger for the event type. Additionally, or alternatively, the analytics server may compare the one or more criteria that correspond to the event type to one or more criteria corresponding to one or more triggers and determine the trigger based on the comparison. As noted above, the trigger may be configured to cause a computing device of the one or more vehicles to store and/or transmit data associated with operation of the at least one vehicle in its environment. In examples, the computing device may transmit the data associated with the operation of the at least one vehicle that is determined based on the trigger to the analytics server. In some implementations, the analytics server provides the data associated with the trigger to the at least one vehicle (e.g., to the computing device(s) of the at least one vehicle) to cause the trigger to be implemented and the at least one vehicle. This, in turn, may cause the computing device of the at least one vehicle to transmit data associated with operation of at least one vehicle in an environment. In this way, the analytics server may cause the one or more vehicles to provide data associated with operation of at least one vehicle in an environment that is responsive to the request.

At step 208, the analytics server determines a set of events. For example, the analytics server may determine the set of events from among a plurality of events. In some implementations, the plurality of events are events that are stored in a database of events associated with the analytics server. For example, the analytics server may determine a plurality of events corresponding to the data associated with the operation of the at least one vehicle that was collected before and/or after receiving the request. In some implementations, the analytics server processes (e.g., scans) the data to determine which portions of the data are associated with a plurality of events that are specified by the request.

The analytics server may determine the set of events based on the analytics server scanning the data associated with the operation of the at least one vehicle to identify the data corresponding to the request. The analytics server may be configured to scan the metadata of the data associated with the operation of the at least one vehicle. In some embodiments, the analytics server may set a scanning parameter based on the request. For example, if the request specifies a vehicle speed, the analytics server may only scan the data associated with the vehicle speed that is specified. In this example, the metadata may provide index for each stored arrays of data, and analytics server may reference the index based on the scanning parameter. In some embodiments, the user may select the scanning parameters. For example, the user may select a maximum amount of data to be returned, such as arrays of data and/or image or video data.

The analytics server may scan the data based on a trigger associated with the request. If the scanned results indicate a trigger is satisfied, the analytics server may then select the data responsive to the request based on the satisfaction of the trigger. As described above, the trigger may specify one or more aspects of the operation of the at least one vehicle that may satisfy the trigger. In this example, the analytics server may transmit portions of the data satisfying the request (e.g., that correspond to the type of vehicle operational parameters specified by the request).

The analytics server may determine the set of events based on comparing one or more event types specified by the request to one more event types corresponding to the one or more tags of each event (of the plurality of events). When doing so, the analytics server may determine the set of events where each event of the set of events corresponds to one or more points in time that are included in the at least one period of time during which the plurality of events occurred. In examples, the at least one period of time may be specified in the request. Additionally, or alternatively, the at least one period of time may be determined based on the data associated with operation of at least one vehicle in an environment that is available to the analytics server when responding to the request.

At step 210, the analytics server generates event data. For example, the analytics server may generate event data that is associated with the operation of the at least one vehicle in the environment that is responsive to the request. The event data may correspond to (e.g., be a copy of) portions of the data associated with operation of at least one vehicle in an environment that is associate with a request. In some examples, the event data is associated with (e.g., represents) each event of the set of events. In some implementations, the event data is generated based on the set of events and the data generated during the operation of the at least one vehicle at the points in time corresponding to the occurrence of each event in the set of events.

At step 212, the analytics server provides the event data. For example, the analytics server may provide (e.g., transmit and/or otherwise make available for download) the event data to the computing device that generated and/or transmitted the request to the analytics server. In some implementations, the analytics server may provide the event data via one or more application programming interfaces (API). For example, where the analytics server receives the data associated with the request via an API (referred to as an API request), the operations described at one or more steps herein may be performed and the event data generated by the analytics server. In this example, the analytics server may then provide the event data via the API (referred to as an API response). In some implementations, the data is provided in one or more formats (e.g., a JSON, XML, and/or plain text format).

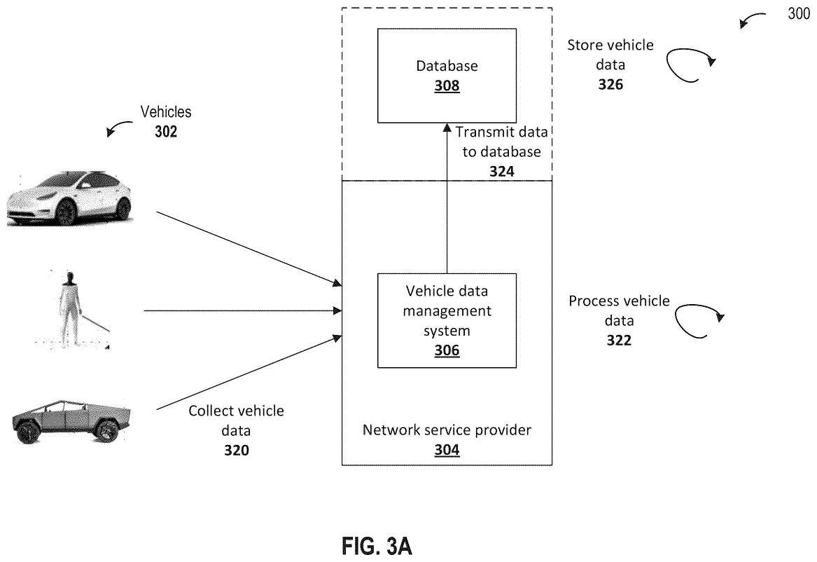

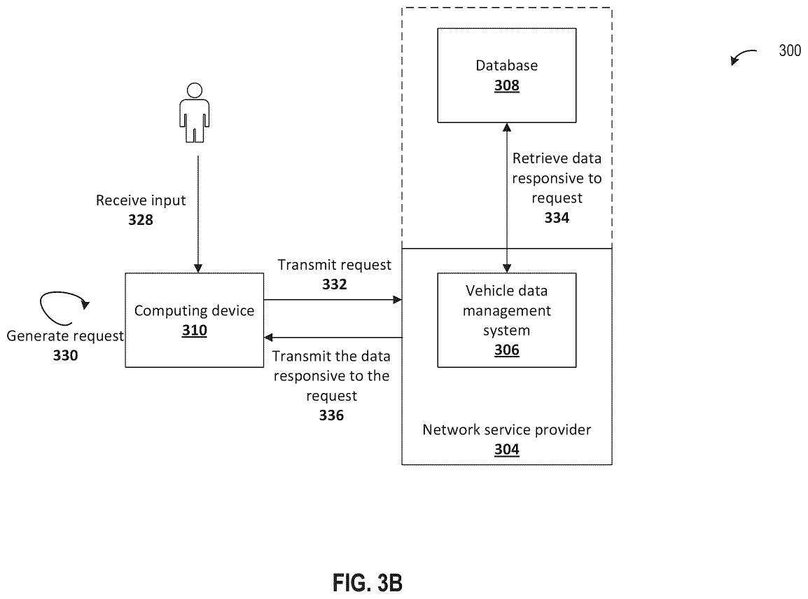

Referring now to FIGS. 3A and 3B, depicted are block diagrams of an implementation 300 relating to a process for managing vehicle data. The implementation 300 can involve any of the components described herein, such as vehicles 302 (e.g., vehicles that are the same as, or similar to, egos 140 of FIG. 1A), a network service provider 304 (e.g., a computing device associated with (e.g., controlled by) an organization that manages at least a portion of the infrastructure involved in communication between device via a network), a vehicle data management system 306 (e.g., a computing device that is the same as, or similar to, the analytics server 110a of FIG. 1), a database 308, and/or a computing device 310 (e.g., a computing device that is associated with one or more users as described herein). While the implementation 300 may be executed by the network service provider 304 in cooperation with the vehicle data management system 306 as described herein, one or more aspects of the implementation 300 may be executed by any number of computing devices operating in the distributed computing system (e.g., a distributed computing system that is the same as, or similar to, the that described in FIGS. 1A-1C). For instance, one or more computing devices of an ego may perform some or all steps described in FIGS. 3A and 3B locally or in coordination with the analytics server.

The vehicles 302, network service provider 304, vehicle data management system 306, database 308, and/or computing device 310 may be any computing device comprising a processor and non-transitory machine-readable storage capable of executing the various tasks and processes described herein. Non-limiting examples of such computing devices may include workstation computers, laptop computers, server computers, and the like, which are not expressly illustrated for purposes of clarity. Further one or more of the vehicles 302, network service provider 304, vehicle data management system 306, database 308, and/or computing device 310 may interconnect with one another through a network (e.g., a network that is the same as, or similar to, network 130 of FIG. 1A).

Referring now to FIG. 3A, as illustrated by operation 320, the network service provider 304 collects vehicle data from the vehicles 302. The vehicle data may include data associated with the operation of at least one vehicle of the vehicles 302. For example, the vehicle data can include camera data (sometimes referred to as vision system data) that is associated with one or more sensors signals generated by one or more cameras as described herein.

As illustrated by operation 322, the network service provider 304 processes the vehicle data. For example, the network server provider 304 may cause the vehicle data management system 306 to process the vehicle data. In this example, the network service provider 304 may cause the vehicle data management system 306 to process the vehicle data based on (e.g., in response to) the network service provider 304 collecting the vehicle data. While illustrated as a single network service provider 304, in some examples multiple network service providers may be positioned at different geographic locations and configured to collect the vehicle data associated with the geographic locations. In some examples, the vehicle data management system processes the vehicle data by converting the vehicle data into arrays of vehicle data signals. The vehicle data management system 306 can be configured to process the collected data into arrays of signal data. For example, vehicle data management system 306 may process the one or more sensor signals generated by the one or more cameras (where sets of camera signals are sometimes referred to as video clips) received from the vehicles. Processing can include adapting the signals to a normalized format, such as the format shown in below Tables 1a, 1b, and 1c.

TABLE 1a

| 01:56 | 01:57 | 01:58 | 01:59 | 02:00 | 02:01 | 02:02 | 02:03 | 02:04 | 02:05 |
|---|---|---|---|---|---|---|---|---|---|
| PM | PM | PM | PM | PM | PM | PM | PM | PM | PM |
| 60 mph | 66 mph | 70 mph | 66 mph | 80 mph | 60 mph | 75 mph | 78 mph | 95 mph | 55 mph |

TABLE 1b

| 01:56 | 01:57 | 01:58 | 01:59 | 02:00 | 02:01 | 02:02 | 02:03 | 02:04 | 02:05 |
|---|---|---|---|---|---|---|---|---|---|
| PM | PM | PM | PM | PM | PM | PM | PM | PM | PM |
| 100% | 99% | 98% | 97% | 78% | 60% | 50% | 48% | 47% | 46% |

TABLE 1c

| 01:56 | 01:57 | 01:58 | 01:59 | 02:00 | 02:01 | 02:02 | 02:03 | 02:04 | 02:05 |
|---|---|---|---|---|---|---|---|---|---|
| PM | PM | PM | PM | PM | PM | PM | PM | PM | PM |
| Heater | Heater | Heater | Heater | Heater | Heater | Heater | Heater | Heater | Heater |
| off | off | off | off | on | on | on | off | off | off |

As shown in Table 1a, the vehicle speed signal is represented in an array of time stamps and vehicle speeds. As shown in Table 1b, the vehicle battery status signal is represented in an array of time stamps and vehicle battery statuses. As shown in Table 1c, the vehicle heater operation signal is represented in an array of time stamps and vehicle heater operation states. These arrays can be stored individually or as a metadata (e.g., metadata corresponding to other vehicle data such as, for example, camera data and/or the like). Tables 1a, 1b, and 1c are merely provided as examples, and the present disclosure is not limited thereto.

In some embodiments, the vehicle data management system 306 can also process the vehicle data by grouping the vehicle data based on vehicle signals generated by particular vehicles. In some embodiments, portions of the vehicle data received from a plurality of vehicles can be stored as a plurality of arrays that each represents a vehicle signal, such as shown in above tables. In these embodiments, the arrays can be grouped based on a different, representative vehicle signal. For example, vehicle data received from multiple vehicles (e.g., a first, second, and third vehicle) can be processed as arrays, such as arrays of vehicle speed and time and vehicle jerking incident and time are represented for each vehicle, grouped with arrays generated in accordance with other signals (e.g., vehicle speed signals, vehicle batter status signals, and vehicle heater operation signals). In this example, the array of vehicle speed and time associated with vehicles can be grouped. Thus, if the third parties request a vehicle data with high speed, the network service provider may only scan the group of vehicle data that indicates the vehicle speed and other vehicle data corresponding to the vehicle data that indicates such vehicle speed.

As illustrated by operation 324, the network service provider 304 causes the vehicle data management system 306 to transmits the vehicle data to the database 308. In examples where multiple network server providers are positioned at different geographic locations, one or more databases may be collocated, located in proximity to, and/or be otherwise in communication with one or more of the multiple network service providers. In this way, a network (not explicitly illustrated) can be formed, enabling the vehicle data to be retrieved from network service providers that are located closer to computing devices requesting some or all of the vehicle as described below. As illustrated, optionally, the database 308 may be included in (e.g., implemented by) the network service provider 304.

As s illustrated by operation 326, the database 308 stores the vehicle data. For example, the database 308 may store the vehicle data based on (e.g., in response to) receiving the vehicle data from the network service provider 304.

Referring now to FIG. 3B, as illustrated by operation 328, a computing device 310 receives input from a user. The input may be associated with (e.g., represent) a request for at least a portion of the vehicle data. The input may be represented in any suitable form, such as by using Python code, JavaScript Object Notation (JSON), and/or the like.

As illustrated by operation 330, the computing device 310 generates a request. For example, the computing device 310 may generate a request based on the computing device 310 receiving the input from the user. The request may specify one or more events (e.g., one or more event types as described herein) that correspond to vehicle data to be retrieved. As illustrated by operation 332, the computing device 310 transmits the request to the network service provider 304. This may cause the network service provider 304 to cause one or more other devices (e.g., the vehicle data management system 306) to process the request and return the vehicle data responsive to the request.

As illustrated by operation 334, the network service provider 304 retrieves data responsive to the request from the database 308. For example, the network service provider 304 may retrieve the data responsive to the request based on the network service provider 304 processing the request. Alternatively, data associated with the input from the user may be provided directly to the network service provider, which in turn may process the input to identify the third party's request. For example, the input may be provided as a logical representation of a query for vehicle data associated with vehicle speeds above a speed limit of 60 mph. In some embodiments, the input may be written in a customizable format, such as by including any query related to the vehicle operational parameters, environment, driver's behavior, etc.

In some implementations, the input may be analyzed by the vehicle data management system 306 the vehicle data management system 306 can receive the input as one or more triggers (sometimes referred to as triggering events). In these embodiments, the input can be in the form computer-executable data, such as executable scripts, that trigger based on an event specified by the input of the third parties. For example, a trigger (e.g., a triggering action) can be based on a preset vehicle operational parameter, such as the determination that a vehicle's location falls within the defined geographic boundary information (e.g., entering into a geofence) or that a vehicle's operational parameter is above a preset threshold value. In some embodiments, the vehicle data management system 306 may perform a debugging of the input and update the input if there are any errors.

In some implementations, the vehicle data management system 306 scans the database 308 to provide the vehicle data related to the third party's request. The vehicle data management system 306 can be configured to scan the metadata stored in the database 308. In some embodiments, the vehicle data management system 306 may set the scanning parameter based on the identified input. For example, if the identified input is related to a vehicle speed, the vehicle data management system 306 may only scan the vehicle data related to the vehicle speed. In this example, the metadata may provide an index for each stored array of data, and the vehicle data management system 306 may reference the index to determine the scanning parameter. In some embodiments, the third parties may select the scanning parameters. For example, the third parties may select the maximum number of vehicle data, such as arrays of data and/or image or video data.

In some embodiments, the vehicle data management system 306 scans the stored vehicle data based on a trigger provided as input. If the scanned results indicates a trigger is satisfied, the vehicle data management system 306 can then select the vehicle data that will be transmitted to the third parties who requested the vehicle data associated with the trigger. As described above, the trigger can, in some embodiments, specify the particular data or data types that will be transmitted to the third party. For example, the selected data can correspond to the type of vehicle operational parameters, service to be provided, user preference, service provider preferences, and the like. For example, the vehicle data can include software visioning information, diagnostic logs, sensor values, user information, language preferences, and the like.

As illustrated by operation 336, the network service provider 304 transmits the data responsive to the request to the computing device 310.

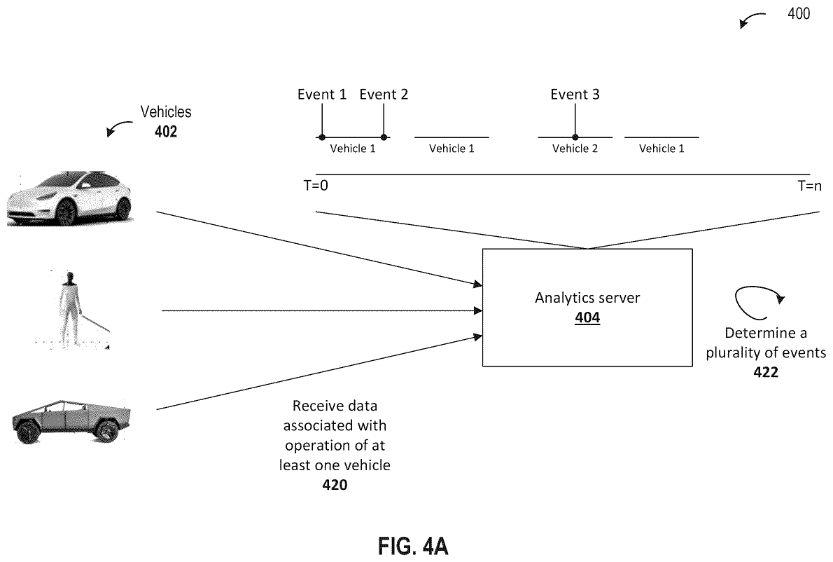

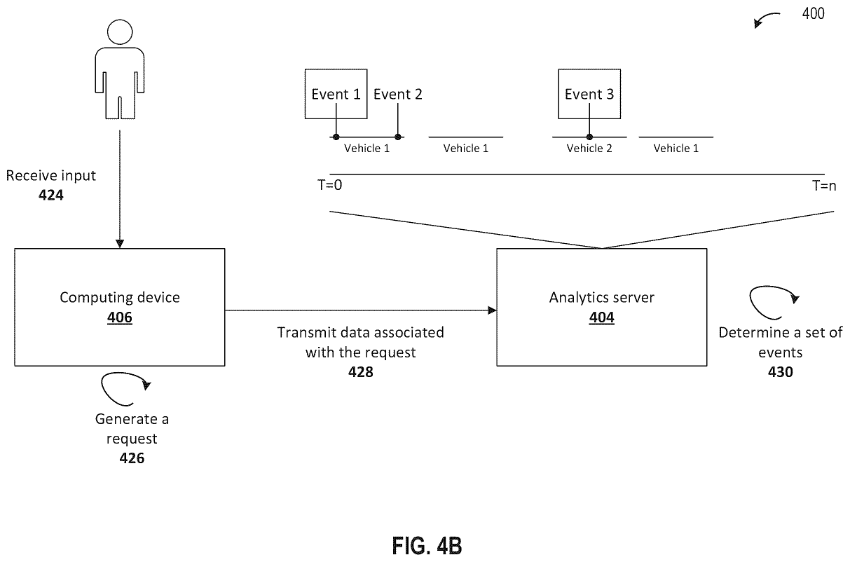

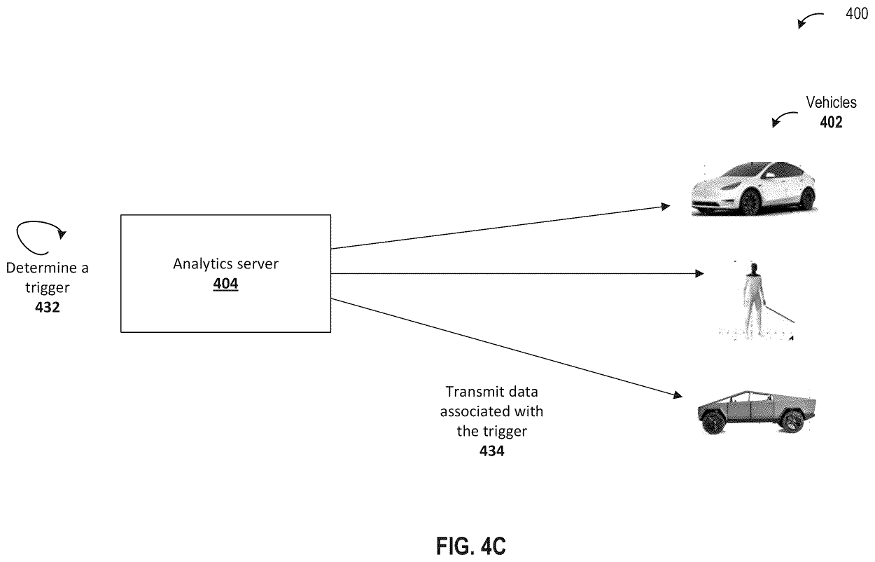

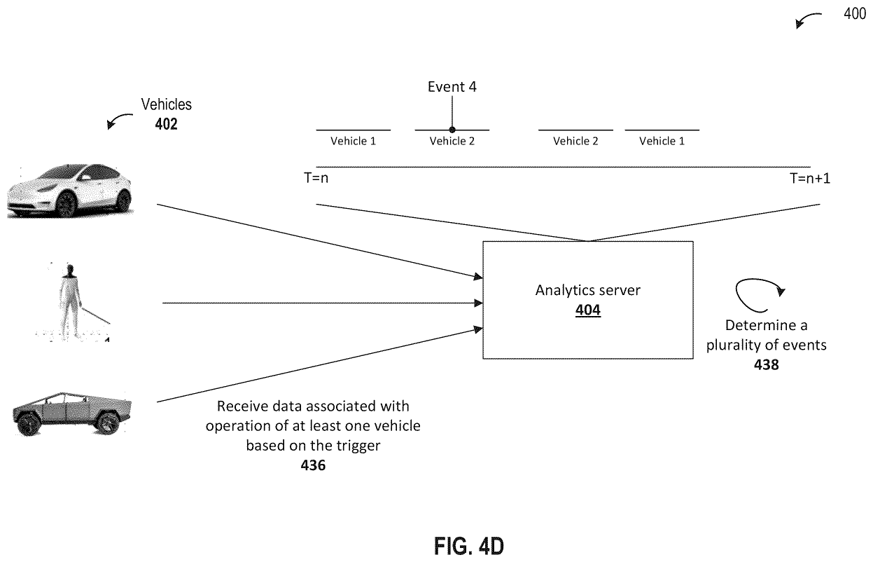

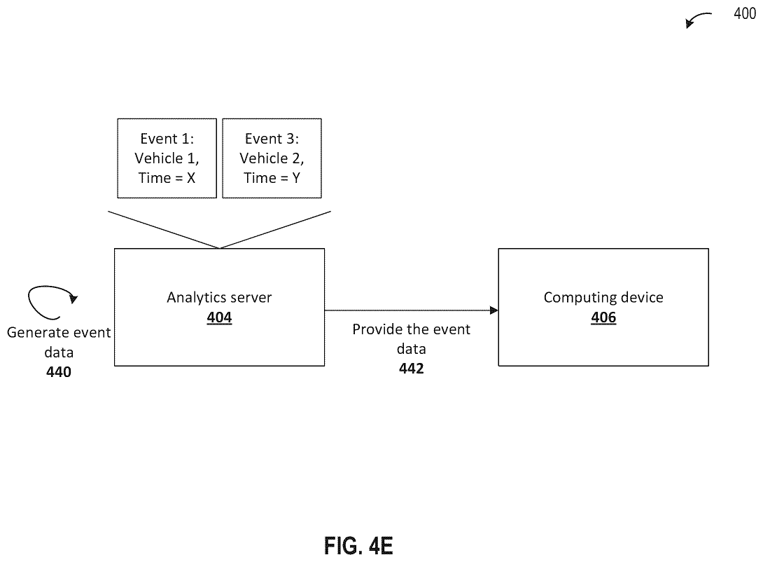

Referring now to FIGS. 4A-4C, depicted are block diagrams of an implementation 400 relating to a process for identification of subsets of data in a dataset that are responsive to requests. The implementation 400 can involve any of the components described herein, such as vehicles 402, an analytics server 404, and a computing device 406. While the implementation 300 may be executed by one or more of the vehicles 402 (e.g., vehicles that may be the same as, or similar to, egos 140 of FIG. 1A), the analytics server 404 (e.g., an analytics server that is the same as, or similar to, the analytics server 110a of FIG. 1A), and a computing device 406 (e.g., a computing device that is the same as, or similar to, administrator computing device 120 and/or server 160 of FIG. 1A), one or more aspects of the implementation 400 may be executed by any number of computing devices operating in the distributed computing system (e.g., a distributed computing system that is the same as, or similar to, the that described in FIGS. 1A-1C). For instance, one or more computing devices of an ego may perform some or all steps described in FIGS. 4A-4C locally or in coordination with the analytics server.

As illustrated by operation 420 of FIG. 4A, the analytics server 404 receives data associated with operation of at least one vehicle. The at least one vehicle includes vehicles 402 (e.g., vehicles that are the same as, or similar to, egos 140 of FIG. 1). In some implementations, the analytics server receives the data associated with operation of at least one vehicle periodically, conditionally, or continuously.

As illustrated by operation 422, the analytics server 404 determines a plurality of events. For example, the analytics server 404 determines a first event (“Event 1”) and a second event (“Event 2”) where the first and second event are associated with operation of a first vehicle (“Vehicle 1”). As shown, the events both occur during a period of time between T=0 and T=n. The period of time corresponds to a period during which Vehicle 1 is operated. As further shown by FIG. 4A, there the analytics server 404 does not determine any events during the operation of vehicle 1 at other points in time. The analytics server 404 also determines a third event (“Event 3”) where the third event is associated with operation of a second vehicle (“Vehicle 2”).

Referring now to FIG. 4B, as illustrated by operation 424, the computing device 406 receives input from a user. The input may specify one or more parameters that can be used to generate a request. For example, the input may specify one or more parameters representing operation of vehicles above a threshold speed (e.g., at or above 60 mph). As illustrated by operation 426, the computing device 406 generates a request. The request is generated based on the input received from the user and specifies one or more events (e.g., one or more event types associated with one or more events). The computing device 406 may then generate data associated with the request that can be transmitted to the analytics server 404. As illustrated by operation 428, the computing device 406 transmits the data associated with the request to the analytics server 404.

As illustrated by operation 430, the analytics server 404 determines a set of events. In examples, the analytics server 404 determines the set of events based on the analytics server 404 comparing the request to the plurality of events determined by the analytics server 404. Optionally, where additional data is desired (e.g., where a suitable amount of events are unidentified and/or unavailable to the analytics server 404), as illustrated by operation 432, the analytics server 404 determines a trigger. In this example, the analytics server 404 determines the trigger based on the request. As illustrated by operation 434 the analytics server 404 transmits data associated with the trigger to the vehicles 402. The data associated with the trigger may be configured to cause the vehicles 402 (e.g., computing devices associated with the vehicles 402) to monitor the operation of the vehicles for events that satisfy the requirements of the trigger.

Referring now to FIG. 4D, as illustrated by operation 436, the analytics server 404 receives data associated with operation of the at least one vehicle based on the trigger. As illustrated by operation 438, the analytics server then determines a plurality of events based on the data associated with operation of the at least one vehicle. In this example, the plurality of events occurs between a time T=n and a time T=n+1.

Referring now to FIG. 4E, as illustrated by operation 440, the analytics server 404 generates event data associated with one or more events. In this example, the analytics server 404 generates the event data based on the analytics server 404 determining the set of events. The event data represents the events that are included in the set of events. As illustrated by operation 442, the analytics server 404 provides the event data to the computing device 406. The event data may be provided based on the analytics server 404 transmitting the event data to the computing device 406. As illustrated, the analytics server 404 provides the event data to the computing device 406 that generated the request.

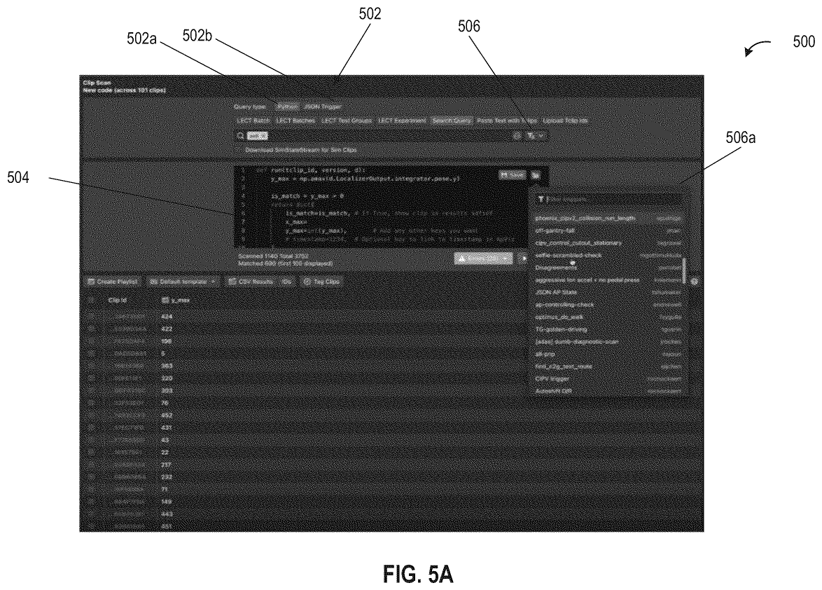

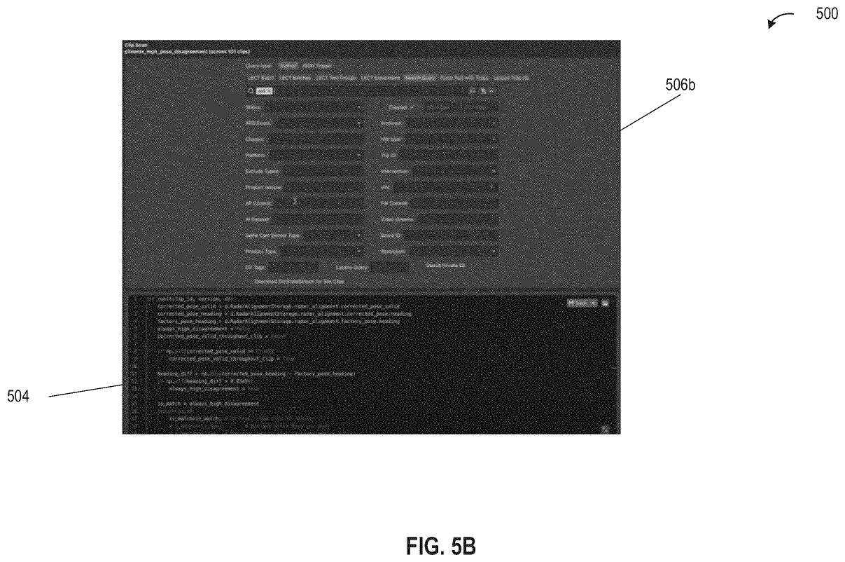

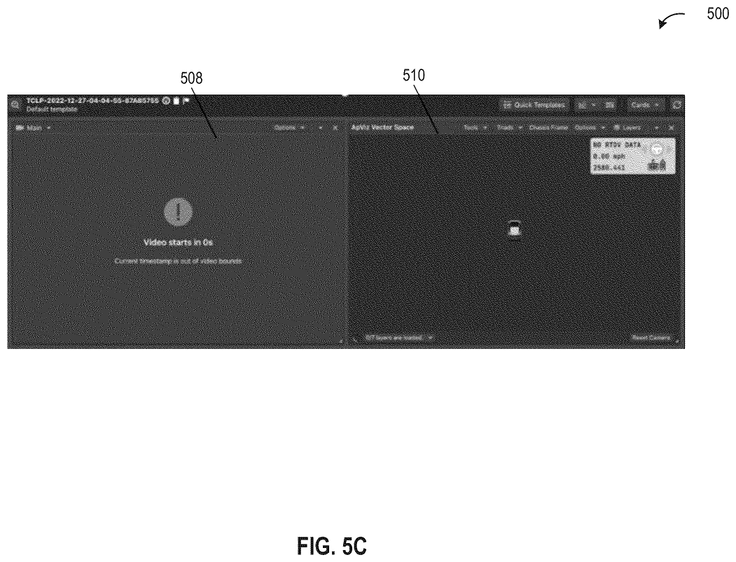

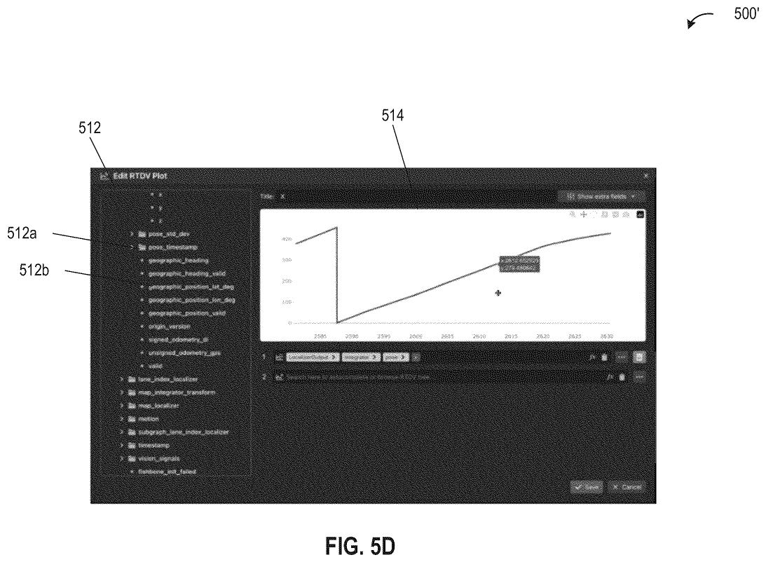

Referring now to FIGS. 5A-5D, depicted is an example user interface for identifying subsets of data in a dataset, in accordance with an embodiment. The user interface 500 may be displayed via one or more computing devices described herein. For example, the user interface 500 may be displayed by a display device (e.g., a monitor and/or the like) of a computing device that is the same as, or similar to, one or more of the analytics server 110a, administrator computing device 120, and/or server 160 of FIG. 1A.

Referring now to FIG. 5A, the user interface 500 includes a query selection region 502. The query selection region 502 includes a first button 502a and a second button 502b. The first button 502a is associated with a first query type (e.g., a Python-based query), and the second button 502b is associated with a second query type (e.g., JSON-based query). In some implementations, the computing device may receive input from a user selecting either the first button 502a or the second button 502b. The computing device may then update the user interface 500 based on the computing device recognizing the selection of either the first button 502a or the second button 502b. In some implementations, the queries described may be the same as, or similar to, the requests described herein.

When the first button 502a or the second button 502b are selected, the computing device may update the user interface 500 to include the query window 504. The query window 504 includes a region which is configured to receive input from users when submitting one or more queries associated with the first query type or the second query type. More specifically, the region associated with the query window 504 may provide a representation of the query as an output that can be reviewed and edited by the user. In some implementations, the region associated with the query window 504 may be associated with a web-based integrated development environment (IDE) such as, for example, Amazon's AWS Cloud9, GitPod, and/or the like. In this way, the user may provide input (e.g., input corresponding to Python-based code and/or any other suitable format) and the computing device may then generate the query based on the user input. In some examples, the computing device may receive input representing one or more script-based queries that represent, for example, scenarios such as vehicle cut-ins (e.g., vehicles moving into the lane of travel of the ego), cut-outs (e.g., vehicles moving out of the lane of travel of the ego), and/or the like.

The computing device may be configured to restimulate operation of one or more egos based on a query. For example, in response to a user providing an input associated with an ego operating under certain conditions (e.g., in light traffic, heavy traffic, and/or the like) the computing device may retrieve data responsive to the query. The computing device may then simulate the operation of one or more components of the ego based on the data responsive to the query. In this example, the user may further update one or more parameters associated with the operation of the ego during the resimulation (e.g., by causing the computing device to simulate operation of the ego based on the data responsive to the query and the one or more updated parameters).

The input received and displayed via the query window 504 may include a query that causes the computing device to retrieve data (e.g., by communicating with a database (e.g., storage units such as the Amazon Web Services S3 storage unit (sometimes referred to as an S3 bucket), a Microsoft Azure Blob Storage container, and/or the like) or another computing device associated with the database, such as an analytics server that is the same as, or similar to, the analytics server 110a of FIG. 1A) based on a predetermined data format. The predetermined data format may define an organization system by which one or more sensor signals of a vehicle are organized as described herein and stored in a database for later retrieval in response to queries. In examples, the predetermined data format may be associated with one or more raw data formats (e.g., unprocessed sensor signals generated by the components of an ego during operation). The raw data may be indexed based on, for example, timestamps and/or the like.

The query window 504 may also present a representation of the query where the query includes one or more scripts that can be executed by a computing device that is hosting data (e.g., data associated with the operation of at least one vehicle). For example, when the first button 502a is selected, one or more queries represented as Python-based scripts may be presented which the computing device uses to query a database; and where the second button 502b is selected, one or more queries represented as JSON-based queries may be presented which the computing device uses to query the same database. In some implementations, the JSON-based query may be the same as, or similar to, triggers as described herein. In some implementations, the computing device generates an HTTP range request based on the Python-based scripts and/or the JSON-based query. In this way, the computing device may query a database to only retrieve the data responsive to the query (e.g., a portion of the data associated with the operation of the at least one vehicle) as opposed to retrieving, for example, all of the data associated with the at least one vehicle. This can be particularly useful in the case where, for example, a user is creating a query for data related to the operation of a specific component of a vehicle (e.g., an ego's windshield wiper operation) but does not want to download other data associated with the operation of the vehicle (e.g., kinematic data, radar data, and/or the like).

The user interface 500 includes a filter button 506. In response to receiving user input selecting the filter button 506, the computing device may display a first filter dropdown menu 506a. Additionally, or alternatively, in response to receiving user input selecting the filter button 506, the computing device may display a second filter menu 506b (see FIG. 5B). Once displayed, the computing device may receive further input selecting one or more buttons on the first filter menu 506a or the second filter menu 506b. The first filter menu 506a and the second filter menu 506b may define one or more predetermined filters that can be applied in addition to, or alternative to, one or more queries. For example, a user may provide data associated with a query formatted in accordance with the first query type and the user may select one or more predetermined filters. The computing device may then apply the one or more predetermined filters before or after querying the database based on the query formatted in accordance with the first query type or the second query type. In the example where the second filter menu 506b is illustrated, the computing device may update the user interface 500 such that the query window 504 is positioned lower relative to a region of the user interface 500 associated with the second filter menu 506b.

Referring now to FIG. 5C, in response to receiving a query, the computing device may update the user interface 500 to display data responsive to the query. For example, as depicted in FIG. 5C, the computing device may update the user interface 500 to include multiple regions corresponding to sensor signals identified as corresponding to the query. The sensor signals may be further associated with data that is associated with the operation of at least one vehicle. For example, the computing device may receive one or more sensor signals responsive to the query and display a representation of the sensors signals via the user interface 500. In one illustrative example, the computing device may display a representation of one or more sensor signals generated by a camera in a region 508 of the user interface 500. In another illustrative example, the computing device may display a representation of one or more sensor signals associated with an autonomous driving or steering system in a region 510. In the latter illustrative example, the representation may be of an ego, one or more trajectories associated with the ego (e.g., one or more proposed and/or an executed trajectory at a point in time), a speed of the ego, a geographic location of the ego, and/or the like.

Referring now to FIG. 5D, the computing device may alternatively present a user interface 500′ representing the sensor signals responsive to the query. In one illustrative example, the computing device generates and provides the user interface 500′ where the sensor signals returned based on the query are sorted. In this example, the user interface 500′ includes a tree region 512 and a data representation region 514. The tree region may include one or more buttons corresponding to the sensor signals, where the sensor signals are sorted into a set of signals and corresponding subsignals. For example, as depicted in FIG. 5D, the tree region includes a button 512a titled “pose_timestamp” referring to the pose (position and orientation) of an ego involved in a query. In response to the computing device receiving input from the user selecting the button titled “pose_timestamp” the computing device may update the tree region 512 to show multiple buttons corresponding to subsignals. The buttons may be titled “geographic_heading” referring to the direction (e.g., north, northeast, east, and/or the like) in which the ego is headed, “geographic_position_lat_degree” referring to a latitude coordinate associate with the location of the ego, “geographic_position_lon_degree” referring to a longitude coordinate associated with the location of the ego, and so on. In response to the user providing input selecting, for example, “pose_timestamp” the computing device may update the data representation region 514 with a representation of one or more sensor signals corresponding to the vehicle pose of one or more egos over a period of time. The representation may be visual (e.g., a graph) and/or character-based (e.g., a table of values).

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Some embodiments of the present disclosure are described herein in connection with a threshold. As described herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like. As used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open ended terms. Further, the phrase “based on” is intended to mean “based at least partially on” unless explicitly stated otherwise.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitates the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system for identifying subsets of data in a dataset, the system comprising:
at least one processor programmed to:
receive data associated with operation of at least one vehicle in an environment, the operation of the at least one vehicle occurring during at least one period of time;
determine a plurality of events that occurred during the at least one period of time based on the operation of the at least one vehicle in the environment, each event of the plurality of events having an event type;
receive, from a computing device, data associated with a request, the request specifying one or more event types;
determine a set of events from among the plurality of events based on the one or more event types specified by the request, each event from the set of events occurring at points in time associated with the at least one period of time;
generate event data associated with the operation of the at least one vehicle in the environment during the points in time corresponding to each event of the set of events; and
transmit the event data to the computing device associated with the request, the event data configured to cause a display associated with the computing device to generate a user interface representing the operation of the at least one vehicle.

2. The system of claim 1, wherein the request specifies at least one event type corresponding to a change in a state of the at least one vehicle, and
wherein, when determining the plurality of events, the at least one processor is programmed to:
determine the change in the state of the at least one vehicle during the at least one period of time.

3. The system of claim 1, wherein, when determining the plurality of events, the at least one processor is programmed to:
determine a presence of one or more scenarios, agents, or objects in the environment at points in time during the at least one period of time.

4. The system of claim 1, wherein, when generating the event data associated with the operation of the at least one vehicle in the environment, the at least one processor is programmed to:
generate the event data based on the set of events and the data generated during the operation of the at least one vehicle at the points in time corresponding to an occurrence of each event in the set of events.

5. The system of claim 1, wherein the at least one processor is further programmed to:
determine a trigger based on the request, the trigger configured to cause a computing device installed in the at least one vehicle to store the data associated with the operation of the at least one vehicle in the environment; and
provide data associated with the trigger to the at least one vehicle, the data associated with the trigger configured to cause the trigger to be implemented by the computing device installed in the at least one vehicle.

6. The system of claim 5, wherein the at least one processor is further programmed to:
receive the data associated with the operation of the at least one vehicle in the environment based on providing the data associated with the trigger to the at least one vehicle.

7. The system of claim 1, wherein the at least one processor is further programmed to:
determine a trigger based on the request, the trigger configured to cause a computing device installed in the at least one vehicle to store the data associated with the operation of the at least one vehicle in the environment; and
determine whether the trigger satisfies a probability threshold based on applying the trigger to the data associated with the operation of the at least one vehicle in the environment.

8. The system of claim 7, wherein the at least one processor is further programmed to:
provide data associated with the trigger to the at least one vehicle, the data associated with the trigger configured to cause the trigger to be implemented by the computing device installed in the at least one vehicle based on determining that the trigger satisfies the probability threshold.

9. The system of claim 7, wherein the at least one processor is further programmed to:
update the trigger based on determining that the trigger does not satisfy the probability threshold; and
provide the data associated with the trigger to the at least one vehicle based on updating the trigger, the data associated with the trigger configured to cause the trigger to be implemented by the computing device installed in the at least one vehicle.

10. A computer-implemented method, comprising:
receiving, by at least one processor, data associated with operation of at least one vehicle in an environment, the operation of the at least one vehicle occurring during at least one period of time;
determining, by the at least one processor, a plurality of events that occurred during the at least one period of time based on the operation of the at least one vehicle in the environment, each event of the plurality of events having an event type;
receiving, by the at least one processor and from a computing device, data associated with a request, the request specifying one or more event types;
determining, by the at least one processor, a set of events from among the plurality of events based on the one or more event types specified by the request, each event from the set of events occurring at points in time associated with the at least one period of time;
generating, by the at least one processor, event data associated with the operation of the at least one vehicle in the environment during the points in time corresponding to each event of the set of events; and
transmitting the event data to the computing device associated with the request, the event data configured to cause a display associated with the computing device to generate a user interface representing the operation of the at least one vehicle.

11. The computer-implemented method of claim 10, wherein, the request specifies at least one event type corresponding to a change in a state of the at least one vehicle, and
wherein determining the plurality of events comprises:
determining the change in the state of the at least one vehicle during the at least one period of time.

12. The computer-implemented method of claim 10, wherein determining the plurality of events comprises:
determining a presence of one or more scenarios, agents, or objects in the environment at points in time during the at least one period of time.

13. The computer-implemented method of claim 10, wherein generating the event data associated with the operation of the at least one vehicle in the environment comprises:
generating the event data based on the set of events and the data generated during the operation of the at least one vehicle at the points in time corresponding to an occurrence of each event in the set of events.

14. The computer-implemented method of claim 10, further comprising:
determining, by the at least one processor, a trigger based on the request, the trigger configured to cause a computing device installed in the at least one vehicle to store the data associated with the operation of the at least one vehicle in the environment; and
providing, by the at least one processor, data associated with the trigger to the at least one vehicle to cause the trigger to be implemented by the computing device installed in the at least one vehicle.

15. The computer-implemented method of claim 14, further comprising:
receiving, by the at least one processor, the data associated with the operation of the at least one vehicle in the environment based on providing the data associated with the trigger to the at least one vehicle.

16. The computer-implemented method of claim 10, further comprising:
determining, by the at least one processor, a trigger based on the request, the trigger configured to cause a computing device installed in the at least one vehicle to store the data associated with the operation of the at least one vehicle in the environment; and
determining, by the at least one processor, whether the trigger satisfies a probability threshold based on applying the trigger to the data associated with the operation of the at least one vehicle in the environment.

17. The computer-implemented method of claim 16, further comprising:
providing, by the at least one processor, data associated with the trigger to the at least one vehicle to cause the trigger to be implemented by the computing device installed in the at least one vehicle based on determining that the trigger satisfies the probability threshold.

18. The computer-implemented method of claim 16, further comprising:
updating, by the at least one processor, the trigger based on determining that the trigger does not satisfy the probability threshold; and
providing, by the at least one processor, data associated with the trigger to the at least one vehicle to cause the trigger to be implemented by the computing device installed in the at least one vehicle based on updating the trigger.

19. A non-transitory machine-readable medium having computer-executable instructions stored thereon that, when executed by one or more processors, cause the one or more processors to perform operations comprising:
receiving data associated with operation of at least one vehicle in an environment, the operation of the at least one vehicle occurring during at least one period of time;
determining a plurality of events that occurred during the at least one period of time based on the operation of the at least one vehicle in the environment, each event of the plurality of events having an event type;
receiving, from a computing device, data associated with a request, the request specifying one or more event types;
determining a set of events from among the plurality of events based on the one or more event types specified by the request, each event from the set of events occurring at points in time associated with the at least one period of time;
generating event data associated with the operation of the at least one vehicle in the environment during the points in time corresponding to each event of the set of events; and
transmitting the event data to the computing device associated with the request, the event data configured to cause a display associated with the computing device to generate a user interface representing the operation of the at least one vehicle.

20. The non-transitory machine-readable medium of claim 19, wherein the request specifies at least one event type corresponding to a change in a state of the at least one vehicle, and
wherein the computer-executable instructions that cause the one or more processors to determine the plurality of events, cause the one or more processors to:
determine the change in the state of the at least one vehicle during the at least one period of time.
